(19) United States
(12) Patent Application Publication
(10) Pub. No.: US 2023/0224988 A1
(43) Pub. Date: Jul. 13, 2023

(54) Extended Device Pairing

(71) Applicant: Google LLC, Mountain View, CA (US)

(72) Inventors: Erik Richard Stauffer, Sunnyvale, CA (US); Jibing Wang, San Jose, CA (US); Aamir Akram, San Jose, CA (US)

(73) Assignee: Google LLC, Mountain View, CA (US)

(21) Appl. No.: 18/150,630

(22) Filed: Jan. 5, 2023

Related U.S. Application Data
(60) Provisional application No. 63/298,004, filed on Jan. 10, 2022.

(51) Int. Cl. H04W 76/14; H04W 4/12

(52) U.S. Cl. CPC H04W 76/14; H04W 4/12

(57) ABSTRACT

Methods, devices, systems, and means for managing extended device pairing by a target device and a host device are described herein. The target device transmits a pairing intent message expressing an intent to pair with the host device (2002), receives a pairing response message in response to the transmitting the pairing intent message (2004), pairs with the host device (2006), and communicates data with the host device (2008).

### CROSS REFERENCE To RELATED APPLICATIONS

This application claims priority under 35 U.S.C. § 119(e) to U.S. Provisional Patent Application Ser. No. 63/298,004 filed Jan. 10, 2022, the disclosure of which is incorporated by reference herein in its entirety.

### BACKGROUND

The evolution of wireless communication to fifth generation (5G) standards and technologies provides higher data rates and greater capacity, with improved reliability and lower latency, which enhances mobile broadband services. 5G technologies also provide new classes of service for vehicular networking, fixed wireless broadband, and the Internet of Things (IoT).

Many of these user devices are capable of connecting to the Internet using cellular or Wireless Local Area Network (WLAN) technologies. Typically, user devices that pair for communication use short-range wireless technologies that limit the communication distance between these devices. However, there is an opportunity to extend the range over which user devices can pair for device-to-device communication.

### SUMMARY

This summary is provided to introduce simplified concepts of extended device pairing. The simplified concepts are further described below in the Detailed Description. This summary is not intended to identify essential features of the claimed subject matter nor is it intended for use in determining the scope of the claimed subject matter.

In aspects, methods, devices, systems, and means for pairing with a host device by a target device describe a target device transmitting a pairing intent message expressing an intent to pair with the host device, receiving a pairing response message in response to the transmitting the pairing intent message, pairing with the host device, and communicating data with the host device.

In other aspects, methods, devices, systems, and means for pairing with a target device by a host device describe the host device transmitting a pairing intent message expressing an intent to pair with the target device, receiving a first pairing response message in response to the transmitting the pairing intent message, pairing with the target device, and communicating data with the target device.

### BRIEF DESCRIPTION OF THE DRAWINGS

The details of one or more aspects of extended device pairing are described below. The use of the same reference numbers in different instances in the description and the figures indicate similar elements:

FIG. 1 illustrates an example operating environment in which aspects of extended device pairing can be implemented.

FIG. 2 illustrates an example device diagram of a host device and a base station.

FIG. 3 illustrates an example device diagram of a Wireless Local Area Network Access Point (WLAN AP) and a target station.

FIG. 4 illustrates an example operating environment in which aspects of extended device pairing can be implemented.

FIG. 5 illustrates example data and control transactions between devices in accordance with aspects of extended device pairing.

FIG. 6 illustrates an example operating environment in which aspects of extended device pairing can be implemented.

FIG. 7 illustrates example data and control transactions between devices in accordance with aspects of extended device pairing.

FIG. 8 illustrates an example operating environment in which aspects of extended device pairing can be implemented.

FIG. 9 illustrates example data and control transactions between devices in accordance with aspects of extended device pairing.

FIG. 10 illustrates an example operating environment in which aspects of extended device pairing can be implemented.

FIG. 11 illustrates example data and control transactions between devices in accordance with aspects of extended device pairing.

FIG. 12 illustrates an example operating environment in which aspects of extended device pairing can be implemented.

FIG. 13 illustrates example data and control transactions between devices in accordance with aspects of extended device pairing.

FIG. 14 illustrates example data and control transactions between devices in accordance with aspects of extended device pairing.

FIG. 15 illustrates example data and control transactions between devices in accordance with aspects of extended device pairing.

FIG. 16 illustrates example data and control transactions between devices in accordance with aspects of extended device pairing.

FIG. 17 illustrates example data and control transactions between devices in accordance with aspects of extended device pairing.

FIG. 18 illustrates example data and control transactions between devices in accordance with aspects of extended device pairing.

FIG. 19 illustrates example data and control transactions between devices in accordance with aspects of extended device pairing.

FIG. 20 illustrates an example method of extended device pairing in accordance with aspects of the techniques described herein.

FIG. 21 illustrates an example method of extended device pairing in accordance with aspects of the techniques described herein.

### DETAILED DESCRIPTION

Wireless technologies, such as Bluetooth and Wi-Fi, provide means to pair devices at relatively close range (e.g., as compared to a cellular link to a base station). Cellular Proximity Services (ProSe) Sidelink, 5G New Radio Unlicensed (NRU), and Integrated Access and Backhaul (IAB) offer methods to pair devices over a medium range (e.g., farther than Bluetooth or Wi-Fi). ProSe and Sidelink devices directly communicate peer-to-peer without a base station. For licensed spectrum, a base station will grant one of the ProSe or Sidelink devices air interface resources for peer-to-peer communications. For IAB, a device functions as a base station for neighboring devices and acts as a UE for backhaul communication with a base-station.

Extending the range of device pairing (perhaps up to one kilometer with direct low band sidelink communications) allows a paired device to make calls, review messages, and stream music without having the host phone on hand. In some instances, the paired device does not need a SIM card, a cellular plan, or need to be in cellular coverage.

To extend pairing distances, devices need to select between available wireless communication technologies, need to be able notify a base station that the devices are pairing, indicate how to pair using licensed or unlicensed radio spectrum, and/or configure a network slice for the paired devices.

### Example Environments

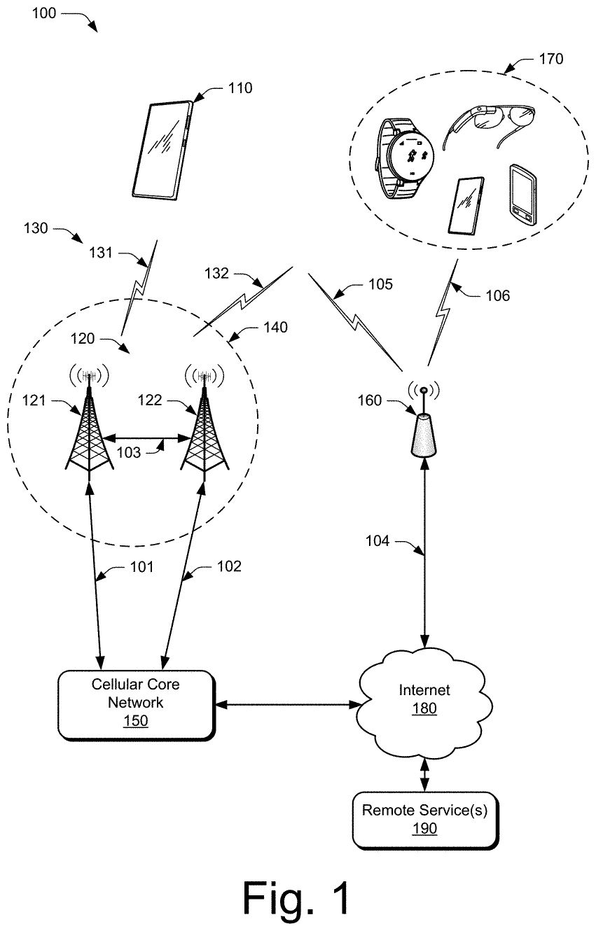

FIG. 1 illustrates an example environment 100, which includes a user equipment 110 (UE 110, host device 110, host 110) that can communicate with base stations 120 (illustrated as base stations 121 and 122) through one or more wireless communication links 130 (wireless link 130), illustrated as wireless link 131. For simplicity, the UE 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, distributed base station, and the like, or any combination or future evolution thereof.

The base stations 120 communicate with the user equipment 110 using the wireless links 131, which may be implemented as any suitable type of wireless link. The wireless link 131 includes control and data communication, such as downlink of data and control information communicated from the base stations 120 to the user equipment 110, uplink of other data and control information communicated from the user equipment 110 to the base stations 120, or both. The wireless links 130 may include one or more wireless links (e.g., radio links) or bearers implemented using any suitable communication protocol or standard, or combination of communication protocols or standards, such as 3rd Generation Partnership Project Long-Term Evolution (3GPP LTE), Fifth Generation New Radio (5G NR), and so forth. In various aspects, the base stations 120 and UE 110 may be implemented for operation in sub-gigahertz bands, sub-6 GHz bands (e.g., Frequency Range 1), and/or above-6 GHz bands (e.g., Frequency Range 2, millimeter wave (mmWave) bands) that are defined by one or more of the 3GPP LTE, 5G NR, or 6G communication standards (e.g., 26 GHz, 28 GHz, 38 GHz, 39 GHz, 41 GHz, 57-64 GHz, 71 GHz, 81 GHz, 92 GHz bands, 100 GHz to 300 GHz, 130 GHz to 175 GHz, or 300 GHz to 3 THz bands). Multiple wireless links 130 may be aggregated in a carrier aggregation or multi-connectivity to provide a higher data rate for the UE 110. Multiple wireless links 130 from multiple base stations 120 may be configured for Coordinated Multipoint (CoMP) communication with the UE 110.

The base stations 120 are collectively a Radio Access Network 140 (e.g., RAN, Evolved Universal Terrestrial Radio Access Network, E-UTRAN, 5G NR RAN or NR RAN). The base stations 121 and 122 in the RAN 140 are connected to a core network 150. The base stations 121 and 122 connect, at 101 and 102 respectively, to the core network 150 through an NG2 interface for control-plane signaling and using an NG3 interface for user-plane data communications when connecting to a 5G core network, or using an S1 interface for control-plane signaling and user-plane data communications when connecting to an Evolved Packet Core (EPC) network. The base stations 121 and 122 can communicate using an Xn Application Protocol (XnAP) through an Xn interface or using an X2 Application Protocol (X2AP) through an X2 interface, at 103, to exchange user-plane and control-plane data. The user equipment 110 may connect, via the core network 150, to public networks, such as the Internet 180 to interact with a remote service 190 (cloud service 190).

The UE 110 also can connect to the Internet 180 using a Wireless Local Area Network (WLAN) connection 105 to a WLAN Access Point 160 (WLAN AP 160), connected to the Internet 180, via the network interface 104. The WLAN AP 160 may be located in a user's home, an office, airport, coffee shop, and so forth. Each WLAN AP 160 may be independently operated, such as in a user's home or may be part of a WLAN network

Additionally in example environment 100, the host device 110 (UE 110) may attempt to pair with a target device 170 (target 170). As discussed below, the target device 170 can include one or more of a cellular (LTE/5G) transceiver, a WLAN transceiver, and/or a Wireless Personal Area Network (WPAN) transceiver. The target device 170 may be another UE 110 such as a smartphone or may be implemented as any suitable computing or electronic device, such as a mobile communication device, modem, cellular phone, gaming device, navigation device, media device, laptop computer, desktop computer, tablet computer, smart appliance, vehicle-based communication system, a smart watch, smart glasses, or an Internet-of-Things (IoT) device such as a sensor or an actuator.

When the target device 170 is equipped with a cellular transceiver, the base stations 120 communicate with the target device 170 using the wireless links 132, which may be implemented as any suitable type of wireless link. The wireless link 132 includes control and data communication, such as downlink of data and control information communicated from the base stations 120 to the target device 170, uplink of other data and control information communicated from the target device 170 to the base stations 120, or both. The target device 170 also can connect to the Internet 180 using a WLAN connection 106 to the WLAN AP 160, connected to the Internet 180, via the network interface 104.

### Example Devices

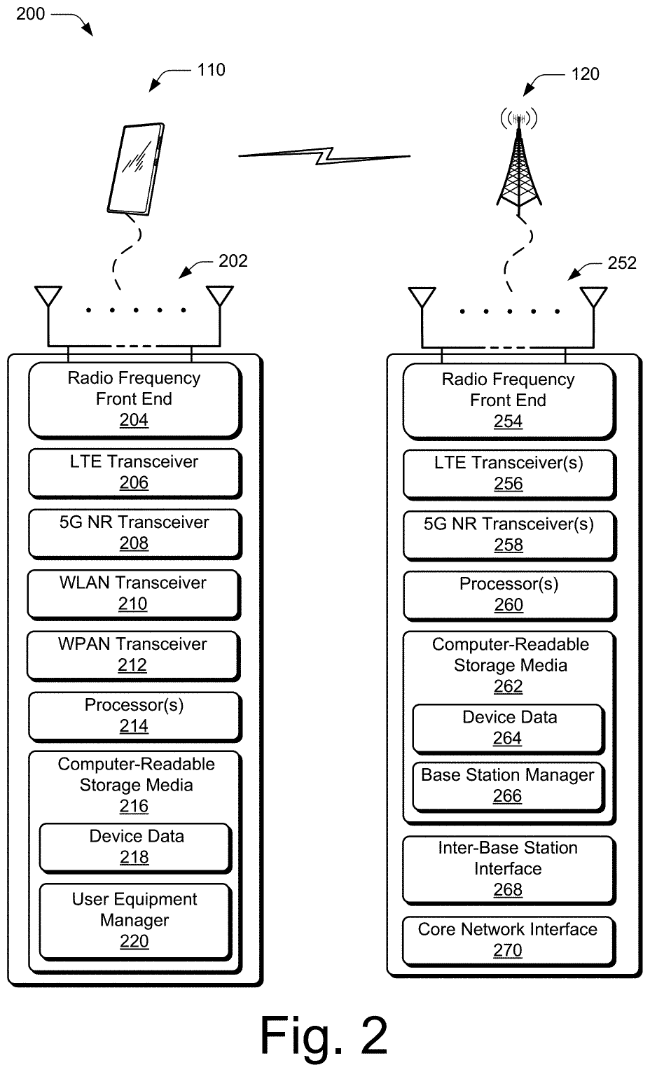

FIG. 2 illustrates an example device diagram 200 of a user equipment (host device) and a base station. In aspects, the device diagram 200 describes devices that can implement various aspects of extended device pairing. Included in FIG. 2 are the UE (host device) 110 and the base stations 120. The UE 110 and the base stations 120 may include additional functions and interfaces that are omitted from FIG. 2 for the sake of clarity. The UE 110 includes antennas 202, a radio frequency front end 204 (RF front end 204), and radio-frequency transceivers (e.g., an LTE transceiver 206 and a 5G NR transceiver 208) for communicating with base stations 120 in the RAN 140. The RF front end 204 of the UE 110 can couple or connect the LTE transceiver 206, and the 5G NR transceiver 208 to the antennas 202 to facilitate various types of wireless communication.

The antennas 202 of the UE 110 may include an array of multiple antennas that are configured similar to or differently from each other. The antennas 202 and the RF front end 204 can be tuned to, and/or be tunable to, one or more frequency bands defined by the 3GPP LTE and 5G NR communication standards and implemented by the LTE transceiver 206, and/or the 5G NR transceiver 208. Additionally, the antennas 202, the RF front end 204, the LTE transceiver 206, and/or the 5G NR transceiver 208 may be configured to support beamforming for the transmission and reception of communications with the base stations 120. By way of example and not limitation, the antennas 202 and the RF front end 204 can be implemented for operation in sub-gigahertz bands, sub-6 GHz bands, and/or above 6 GHz bands that are defined by the 3GPP LTE and 5G NR communication standards.

The UE 110 includes a WLAN transceiver 210 that implements the functions of a WLAN station (STA). The WLAN transceiver 210 may be coupled to the RF front end 204 and antennas 202, may include an RF front end and antennas, or both. The user equipment manager 220 may control the configuration and operation of the WLAN transceiver 210 to coordinate operation in the WLAN and cellular frequency bands, or the configuration and operation of the WLAN transceiver 210 may be distributed between the user equipment manager 220 and the WLAN transceiver 210 in any suitable manner. The WLAN transceiver 210 is configured to operate in any WLAN frequency band and using any protocols defined in the IEEE 802.11 specifications. The WLAN transceiver 210 may also be configured to support beamformed communication.

The UE 110 includes a WPAN transceiver 212 that may be coupled to the RF front end 204 and antennas 202, may include an RF front end and antennas, or both. The user equipment manager 220 may control the configuration and operation of the WPAN transceiver 212 to coordinate operation in the WPAN and cellular frequency bands, or the configuration and operation of the WPAN transceiver 212 may be distributed between the user equipment manager 220 and the WPAN transceiver 212 in any suitable manner. The WPAN transceiver 212 is configured to operate in any WPAN frequency band and using any protocols defined in the Bluetooth, Thread, ZigBee, or similar specifications.

The UE 110 also includes processor(s) 214 and computer-readable storage media 216 (CRM 216). The processor 214 may be a single core processor or a multiple core processor composed of a variety of materials, such as silicon, polysilicon, high-K dielectric, copper, and so on. The computer-readable storage media described herein excludes propagating signals. CRM 216 may include any suitable memory or storage device such as random-access memory (RAM), static RAM (SRAM), dynamic RAM (DRAM), non-volatile RAM (NVRAM), read-only memory (ROM), or Flash memory useable to store device data 218 of the UE 110. The device data 218 includes user data, multimedia data, beamforming codebooks, applications, and/or an operating system of the UE 110, which are executable by processor(s) 214 to enable user-plane communication, control-plane signaling, and user interaction with the UE 110.

CRM 216 also includes a user equipment manager 220 (e.g., a user equipment manager application 220). Alternately or additionally, the user equipment manager 220 may be implemented in whole or part as hardware logic or circuitry integrated with or separate from other components of the UE 110. In at least some aspects, the user equipment manager 220 configures the RF front end 204, the LTE transceiver 206, the 5G NR transceiver 208, the WLAN transceiver 210, and/or the WPAN transceiver 212 to implement the techniques described herein for extended device pairing.

The device diagram for the base stations 120, shown in FIG. 2, includes a single network node (e.g., a gNode B). The functionality of the base stations 120 may be distributed across multiple network nodes or devices and may be distributed in any fashion suitable to perform the functions described herein. The base stations 120 include antennas 252, a radio frequency front end 254 (RF front end 254), one or more LTE transceivers 256, and/or one or more 5G NR transceivers 258 for communicating with the UE 110. The RF front end 254 of the base stations 120 can couple or connect the LTE transceivers 256 and the 5G NR transceivers 258 to the antennas 252 to facilitate various types of wireless communication. The antennas 252 of the base stations 120 may include an array of multiple antennas that are configured similar to or differently from each other. The antennas 252 and the RF front end 254 can be tuned to, and/or be tunable to, one or more frequency band defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 may be configured to support beamforming, such as Massive-MIMO, for the transmission and reception of communications with a UE 110.

The base stations 120 also include processor(s) 260 and computer-readable storage media 262 (CRM 262). The processor 260 may be a single core processor or a multiple core processor composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data 264 of the base stations 120. The device data 264 includes network scheduling data, radio resource management data, beamforming codebooks, applications, and/or an operating system of the base stations 120, which are executable by processor(s) 260 to enable communication with the UE 110.

CRM 262 also includes a base station manager 266 (e.g., base station manager application 266). Alternately or additionally, the base station manager 266 may be implemented in whole or part as hardware logic or circuitry integrated with or separate from other components of the base stations 120. In at least some aspects, the base station manager 266 configures the LTE transceivers 256 and the 5G NR transceivers 258 for communication with the UE 110, as well as communication with a core network. The base stations 120 include an inter-base station interface 268, such as an Xn and/or X2 interface, which the base station manager 266 configures to exchange user-plane and control-plane data between another base station 120, to manage the communication of the base stations 120 with the UE 110. The base stations 120 include a core network interface 270 that the base station manager 266 configures to exchange user-plane and control-plane data with core network functions and entities.

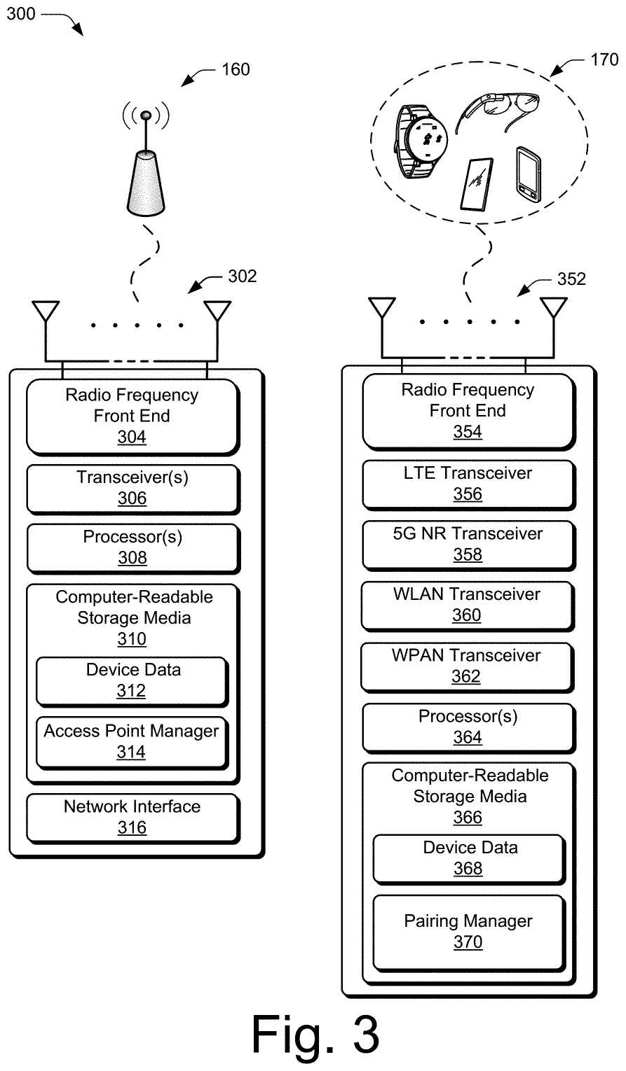

FIG. 3 illustrates an example device diagram 300 of a WLAN access point 160 and a target device 170. In aspects, the device diagram 300 describes devices that can implement various aspects of extended device pairing. The WLAN AP 160 and the target device 170 may include additional functions and interfaces that are omitted from FIG. 3 for the sake of clarity.

The WLAN AP 160 includes antennas 302, a radio frequency front end 304 (RF front end 304), one or more transceivers 306 that are configured for WLAN communication with the UE 110 and/or the target device 170. The RF front end 304 can couple or connect the transceivers 306 to the antennas 302 to facilitate various types of wireless communication. The antennas 302 of the WLAN AP 160 may include an array of multiple antennas that are configured similarly to or differently from each other. The antennas 302 and the RF front end 304 can be tuned to, and/or be tunable to, one or more frequency bands defined by the IEEE 802.11 communication standards and implemented by the transceivers 306. Additionally, the antennas 302, the RF front end 304, and/or the transceivers 306 may be configured to support beamforming for the transmission and reception of communications with the UE 110.

The WLAN AP 160 also includes processor(s) 308 and computer-readable storage media 310 (CRM 310). The processor 308 may be a single core processor or a multiple core processor composed of a variety of materials, such as silicon, polysilicon, high-K dielectric, copper, and so on. CRM 310 may include any suitable memory or storage device such as random-access memory (RAM), static RAM (SRAM), dynamic RAM (DRAM), non-volatile RAM (NVRAM), read-only memory (ROM), or Flash memory useful to store device data 312 of the WLAN AP 160. The device data 312 includes network scheduling data, radio resource management data, applications, and/or an operating system of the WLAN AP 160, which are executable by processor(s) 308 to enable communication with the UE 110 and/or the target device 170.

CRM 310 also includes an access point manager 314, which, in one implementation, is embodied on CRM 310 (as shown). Alternately or additionally, the access point manager 314 may be implemented in whole or part as hardware logic or circuitry integrated with or separate from other components of the WLAN AP 160. In at least some aspects, the access point manager 314 configures the transceivers 306 for communication with the UE 110 and/or the target device 170, as well as communication of user-plane and control-plane data via the Internet 180 via a network interface 316.

The target device 170 includes antennas 352, a radio frequency front end 354 (RF front end 354), and one or more radio-frequency transceivers including an LTE transceiver 356, a 5G NR transceiver 358, a WLAN transceiver 360, and/or a WPAN transceiver 362. The RF front end 354 of the target device 170 can couple or connect the LTE transceiver 356, the 5G NR transceiver 358, the WLAN transceiver 360, and/or the WPAN transceiver 362 to the antennas 352 to facilitate various types of wireless communication.

The antennas 352 of the UE 110 may include an array of multiple antennas that are configured similar to or differently from each other. The antennas 352 and the RF front end 354 can be tuned to, and/or be tunable to, one or more frequency bands defined by the 3GPP LTE and 5G NR communication standards and implemented by the LTE transceiver 356, and/or the 5G NR transceiver 358. Additionally, the antennas 352, the RF front end 354, the LTE transceiver 356, and/or the 5G NR transceiver 358 may be configured to support beamforming for the transmission and reception of communications with the base stations 120 and/or the WLAN AP 160. By way of example and not limitation, the antennas 352 and the RF front end 354 can be implemented for operation in sub-gigahertz bands, sub-6 GHz bands, and/or above 6 GHz bands that are defined by the 3GPP LTE and 5G NR communication standards.

The target device 170 includes a WLAN transceiver 360 that implements the functions of a WLAN station (STA). The WLAN transceiver 360 may be coupled to the RF front end 354 and antennas 352, may include an RF front end and antennas, or both. The WLAN transceiver 360 is configured to operate in any WLAN frequency band and using any protocols defined in the IEEE 802.11 specifications. The WLAN transceiver 360 may also be configured to support beamformed communication.

The UE 110 includes a WPAN transceiver 362 that may be coupled to the RF front end 354 and antennas 352, may include an RF front end and antennas, or both. The WPAN transceiver 362 is configured to operate in any WPAN frequency band and using any protocols defined in the Bluetooth, Thread, ZigBee, or similar specifications.

The target device 170 also includes processor(s) 364 and computer-readable storage media 366 (CRM 366). The processor 364 may be a single core processor or a multiple core processor composed of a variety of materials, such as silicon, polysilicon, high-K dielectric, copper, and so on. The computer-readable storage media described herein excludes propagating signals. CRM 366 may include any suitable memory or storage device such as random-access memory (RAM), static RAM (SRAM), dynamic RAM (DRAM), non-volatile RAM (NVRAM), read-only memory (ROM), or Flash memory useable to store device data 368 of the target device 170. The device data 368 includes user data, multimedia data, beamforming codebooks, applications, and/or an operating system of the target device 170, which are executable by processor(s) 364 to enable user-plane communication, control-plane signaling, and user interaction with the UE 110, the base stations 120, and/or the WLAN AP 160.

CRM 366 also includes a pairing manager 370 (e.g., a pairing manager application 370). Alternately or additionally, the pairing manager 370 may be implemented in whole or part as hardware logic or circuitry integrated with or separate from other components of the target device 170. In at least some aspects, the pairing manager 370 configures the RF front end 354, the LTE transceiver 356, the 5G NR transceiver 358, the WLAN transceiver 360, and/or the WPAN transceiver 362 to implement the techniques described herein for extended device pairing.

### Extended Device Pairing Intent Indication

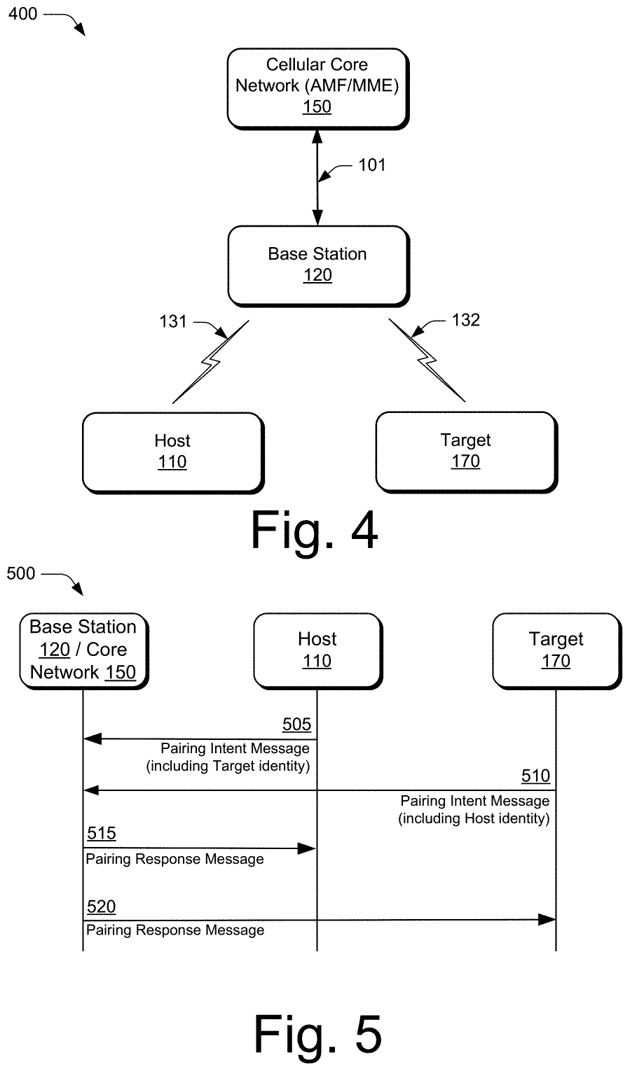

FIG. 4 illustrates a pairing environment between a host device and a target device in accordance with aspects of extended device pairing. FIG. 4 illustrates a pairing intent indication between a host device 110 and a target device 170, both of which are connected to the base station 120 by the wireless links 131 and 132, respectively. Since the host 110 and the target 170 are connected to the base station 120, the host and the target can individually send pairing request messages to the base station 120 and the core network 150, (e.g., to a Mobile Management Entity (MME) or an Access and Mobility Management Function (AMF) in the core network 150).

FIG. 5 illustrates data and control transactions between a host device and a target device for pairing intent message routing in accordance with aspects of extended device pairing as illustrated in FIG. 4. Although not illustrated for the sake of illustration clarity, various acknowledgements for messages illustrated in FIG. 5 may be implemented to ensure reliable operations of extended device pairing.

The host 110 and the target 170 each directly inform the base station 120 and core network 150 of their intent and capability to pair. At 505, the host 110 includes an identifier of the target 170 in a Pairing Intent message and sends the Pairing Intent message to the base station 120 and core network 150. At 510, the target 170 includes an identifier of the host 110 in a Pairing Intent message and sends the Pairing Intent message to the base station 120 and core network 150. At 515 and 520, the base station 120 and core network 150 send Pairing Response messages to the host device and the target device, respectively. The Pairing Response messages may optionally include a grant of air interface resources for the paired communication between the host and target.

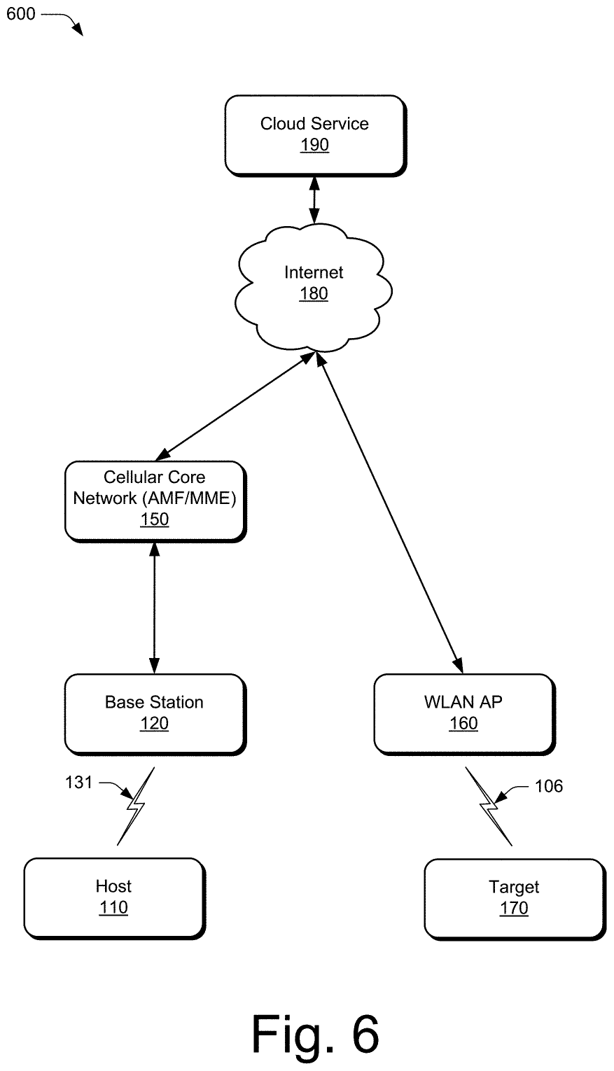

FIG. 6 illustrates a pairing environment between a host device and a target device in accordance with aspects of extended device pairing. FIG. 6 illustrates a pairing intent indication between a host device 110 and a target device 170, both of which are connected to the Internet 180, but do not have a direct connection with each other or a base station, and are connected to the Internet 180 via different communications technologies. In this scenario, the host 110 is connected to the Internet 180 via the base station 120 and the core network 150. The target 170 is connected to the Internet 180 by the wireless link 106 and the WLAN AP 160.

In this scenario, the target 170 connects to the host 110 using the cloud service 190. The host 110 and the target 170 exchange identities using the cloud service 190. After the identities are exchanged, the host 110 shares this information with the base station 120 and the core network 150. In an alternative, the indication of pairing intent in this scenario can apply to a target device 170 that is cellular-capable, but lacks a Subscriber Identity Module (SIM) to enable the target to connect to base station 120 and core network 150.

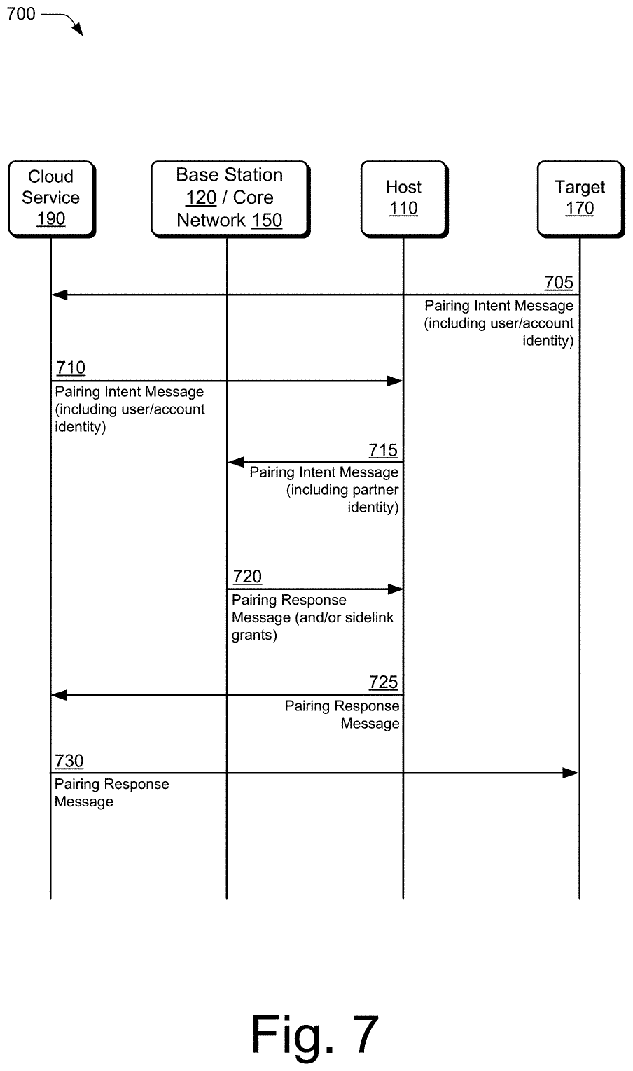

FIG. 7 illustrates data and control transactions between a host device and a target device for pairing intent message routing in accordance with aspects of extended device pairing as illustrated in FIG. 6. Although not illustrated for the sake of illustration clarity, various acknowledgements for messages illustrated in FIG. 7 may be implemented to ensure reliable operations of extended device pairing.

At 705, the target 170 sends a first Pairing Intent message, including a user account or identity, to the cloud service 190. At 710, the cloud service 190 forwards the first Pairing Intent message to the host 110. At 715, in response to receiving the first Pairing Intent message, the host 110 includes a partner identity (the identity of the target 170) in a second Pairing Intent message and sends the second Pairing Intent message to the base station 120/core network 150. At 720, the base station 120/core network 150 sends a Pairing Response message and/or a sidelink resource grant to the host 110. At 725, the host 110 forwards the Pairing Response message and/or the sidelink resource grant to the cloud service 190. At 730 the cloud service relays the Pairing Response message and/or the sidelink resource grant to the target 170 to enable pairing between the host 110 and the target 170.

FIG. 8 illustrates a pairing environment between a host device and a target device in accordance with aspects of extended device pairing. FIG. 8 illustrates a pairing intent indication between a host device 110 and a target device 110 that have a direct connection 801 available (e.g., WLAN, Bluetooth) but the target does not have a cellular connection (either by lacking a cellular transceiver or lacking a SIM to access the cellular network).

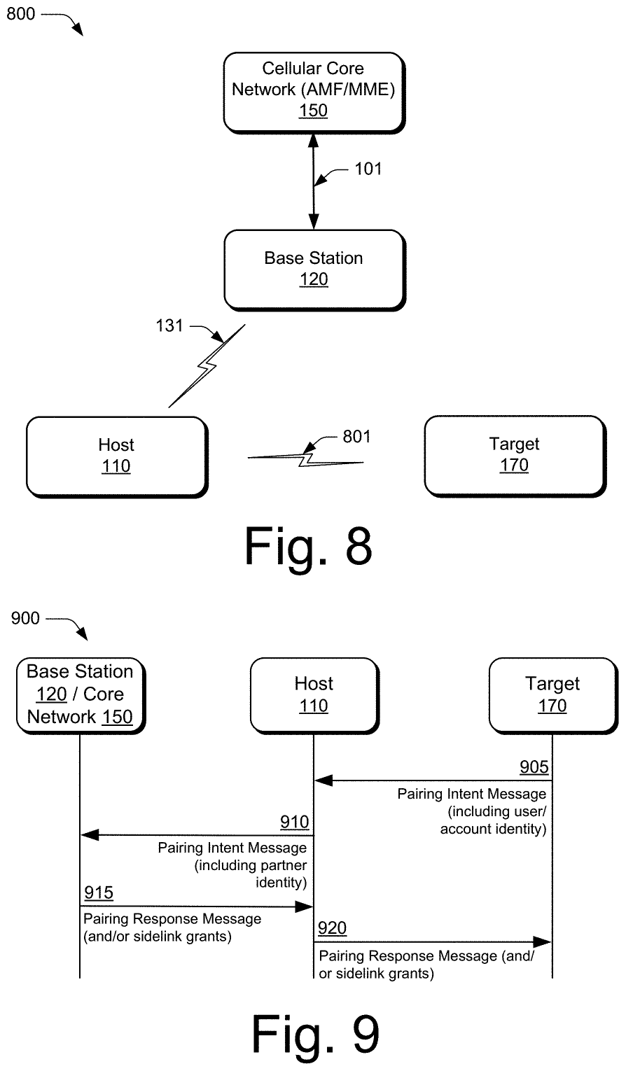

FIG. 9 illustrates data and control transactions between a host device and a target device for pairing intent message routing in accordance with aspects of extended device pairing as illustrated in FIG. 8. Although not illustrated for the sake of illustration clarity, various acknowledgements for messages illustrated in FIG. 9 may be implemented to ensure reliable operations of extended device pairing.

At 905, the target 170 sends a Pairing Intent message, including a user account or identity, to the host 110. At 910, the host 110 forwards the Pairing Intent message to the base station 120/core network 150. At 915, the base station 120/core network 150 sends a Pairing Response message and/or a sidelink resource grant to the host 110. At 920, the host 110 forwards the Pairing Response message and/or the sidelink resource grant to the target 170.

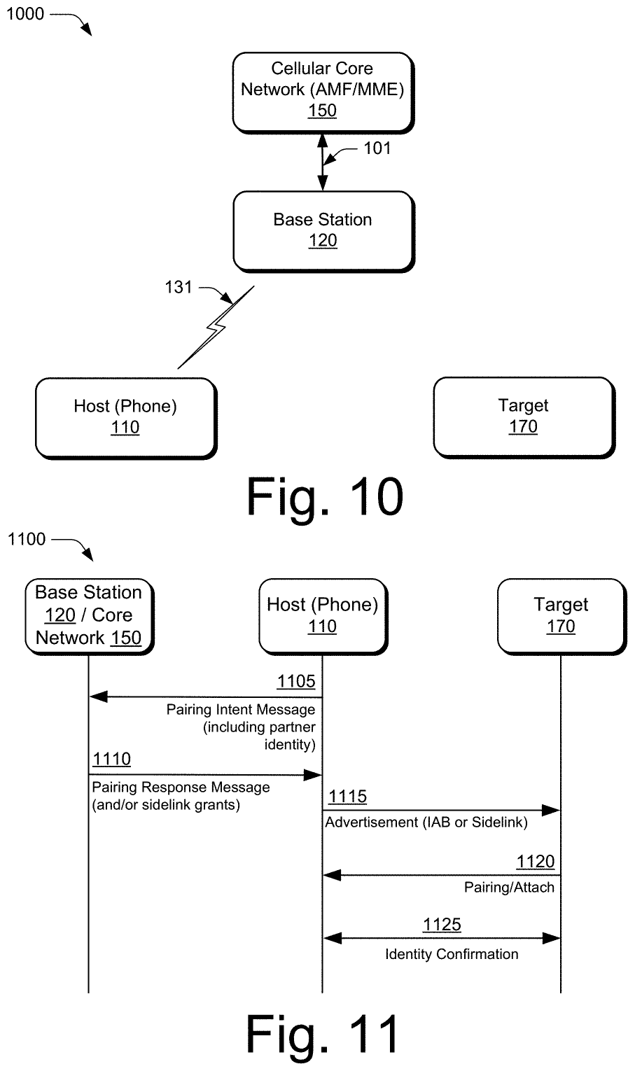

FIG. 10 illustrates a pairing environment between a host device and a target device in accordance with aspects of extended device pairing. FIG. 10 illustrates a pairing intent indication between a host device 110 and a target device 110 that have no connection available between them. The host 110 has a connection to the cellular network but the but the target does not have a cellular connection (either by lacking a cellular transceiver or lacking a SIM to access the cellular network).

FIG. 11 illustrates data and control transactions between a host device and a target device for pairing intent message routing in accordance with aspects of extended device pairing as illustrated in FIG. 10. Although not illustrated for the sake of illustration clarity, various acknowledgements for messages illustrated in FIG. 11 may be implemented to ensure reliable operations of extended device pairing.

The user can initiate pairing on the host and the target. At 1105, the host 110 sends a Pairing Intent message, including a user account or identity, to the base station 120/core network 150. At 1110, the base station 120/core network 150 sends grants for the host 110 to advertise itself (in the case of Integrated Access and Backhaul (IAB) or sidelink). At 1115, the host 110 advertises its IAB or sidelink capabilities. The user initiates a search at the target device 170 to discover the host 110. At 1120, the target 170 initiates pairing with the host 110, such as by transmitting a pairing or attach message to the host. At 1125, the identity of the target device is confirmed by the host. Optionally or additionally, if multiple links are possible (TAB, Sidelink, Wi-Fi Direct, Bluetooth), the target device can select the preferred link, such as based on signal strengths of the multiple links.

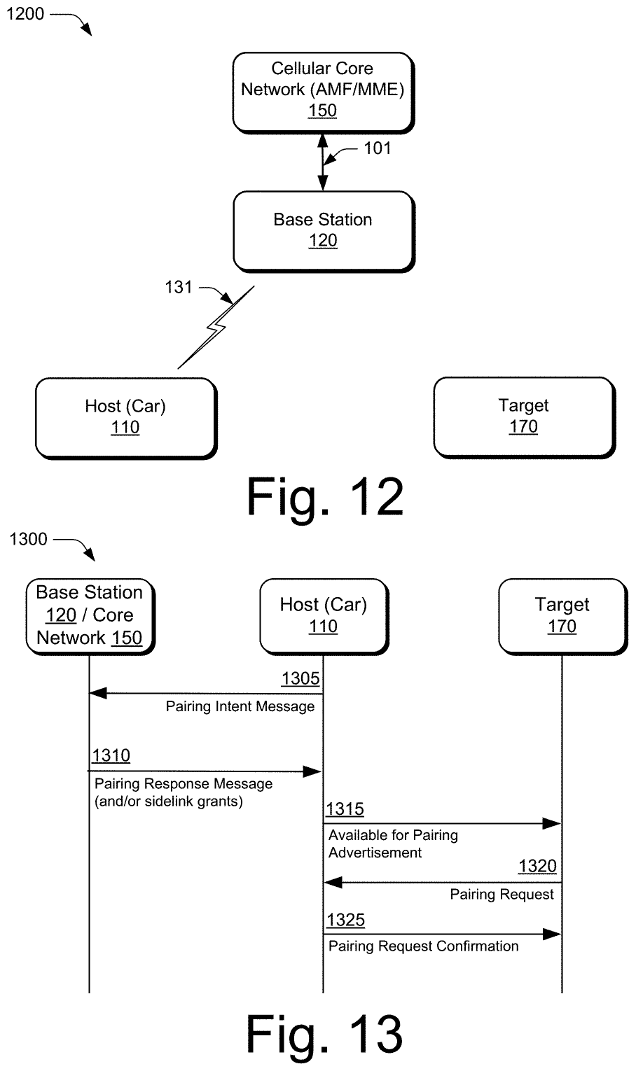

FIG. 12 illustrates a pairing environment between a host device and a target device in accordance with aspects of extended device pairing. FIG. 12 illustrates a pairing intent indication between a target device 170 and a host device 110 that is not known to the target device (e.g., a car or a hotspot service). The host 110 has a connection to the cellular network but the but the target does not have a cellular connection (either by lacking a cellular transceiver or lacking a SIM to access the cellular network).

FIG. 13 illustrates data and control transactions between a host device and a target device for pairing intent message routing in accordance with aspects of extended device pairing as illustrated in FIG. 12. Although not illustrated for the sake of illustration clarity, various acknowledgements for messages illustrated in FIG. 13 may be implemented to ensure reliable operations of extended device pairing.

The user initiates pairing on the host and the target. At 1305, the host 110 sends a Pairing Intent message to the base station 120/core network 150. At 1310, the base station 120/core network 150 sends grants for the host 110 to advertise itself (in the case of Integrated Access and Backhaul (TAB) or Sidelink). At 1315, the host 110 transmits an advertisement that the host is available for pairing. At 1320, the target 170 initiates pairing with the host 110. At 1325, the host 110 confirms the pairing by transmitting a Pairing Request Confirmation message to the target 170.

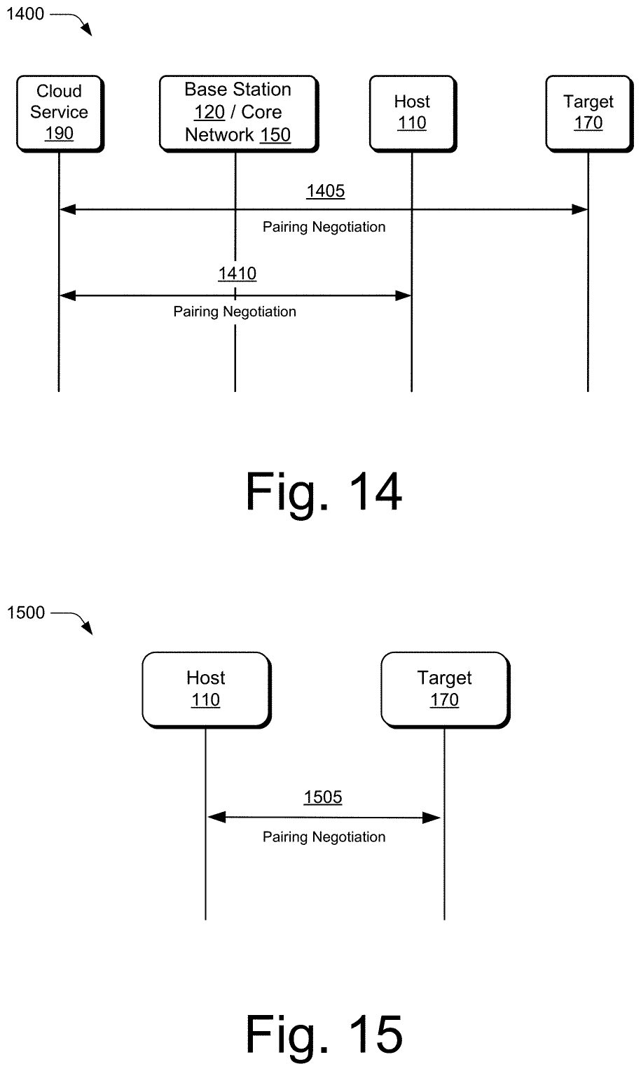

In some aspects, such as those described with respect to FIGS. 6-9, the pairing of the host and target may be consummated using a non-cellular technology, such as Wi-Fi, Bluetooth, or another suitable wireless technology. A negotiation of pairing parameters can include the exchange of Pairing Intent Messages, Pairing Response messages, and/or any other messages usable to complete the negotiation. In the negotiation, the Pairing Intent message can include a list of capabilities of the host device and/or target device, such as available radio technologies and/or a list of signal characteristics such as Signal to Noise Ratio (SNR), Received Signal Strength Indication (RSSI), or the like. In the negotiation, the Pairing Response message can include a selected wireless technology for the pairing and/or request additional radio measurements to assist in selecting a wireless technology for the pairing. As illustrated in FIGS. 14 and 15, the pairing negotiation can be conducted indirectly or directly between the hose and target.

FIG. 14 illustrates data and control transactions between a host device and a target device for indirect pairing negotiations in accordance with aspects of extended device pairing. Although not illustrated for the sake of illustration clarity, various acknowledgements for messages illustrated in FIG. 14 may be implemented to ensure reliable operations of extended device pairing.

Indirect pairing negotiations between the host and target can be conducted via the cloud service 190. At 1405, the target 170 communicates pairing negotiation messages to the host 110 via the cloud service 190. At 1410, the host 110 communicates pairing negotiation messages to the target 170 via the cloud service 190. Although a single iteration of pairing negotiations is illustrated, the communications illustrated at 1405 and 1410 may be repeated as needed to complete the negotiation between the host and target.

FIG. 15 illustrates data and control transactions between a host device and a target device for direct pairing negotiations in accordance with aspects of extended device pairing. Although not illustrated for the sake of illustration clarity, various acknowledgements for messages illustrated in FIG. 14 may be implemented to ensure reliable operations of extended device pairing. At 1505, direct pairing negotiations between the host and target are conducted by directly exchanging pairing negotiation messages between the host and the target. Although a single pairing negotiation is illustrated, the communications illustrated at 1505 may be repeated as needed, or include multiple communications, to complete the negotiation between the host and target.

The target device can request to pair with a host device in response to an advertisement from the host device. For example, when using technologies such as IAB or Sidelink in licensed spectrum, the host device 110 can advertise itself using spectrum grants from the base station 120. In another example, when using unlicensed spectrum, the host device transmits beacons. The target device uses a Listen-Before-Talk (LBT) random access procedure to transmit a pairing request in response to the beacon. Additionally, Bluetooth and/or Wi-Fi service discovery techniques may be used to assist in pairing.

In an aspect, a pairing-link technology can be selected over an existing link by either the target or the host. For example, the selection can be facilitated by an availability indication in a Master Information Block (MIB) or a System Information Block (SIB), in a Radio Resource Control (RRC) message after connection, or based on signal measurements such as Received Signal Strength Indication (RSSI), Reference Signal Received Power (RSRP), or Signal to Interference and Noise Ratio (SINR), if multiple technologies are advertising pairing availability. In further aspects, a change to a pairing link may include a transition between licensed and unlicensed radio spectrum. In the event of a transition from unlicensed to licensed spectrum, approval and a grant from a base station is required. Additionally, in selecting between pairing-link technologies, a preference for licensed or unlicensed spectrum may be factored into the selection of a pairing technology.

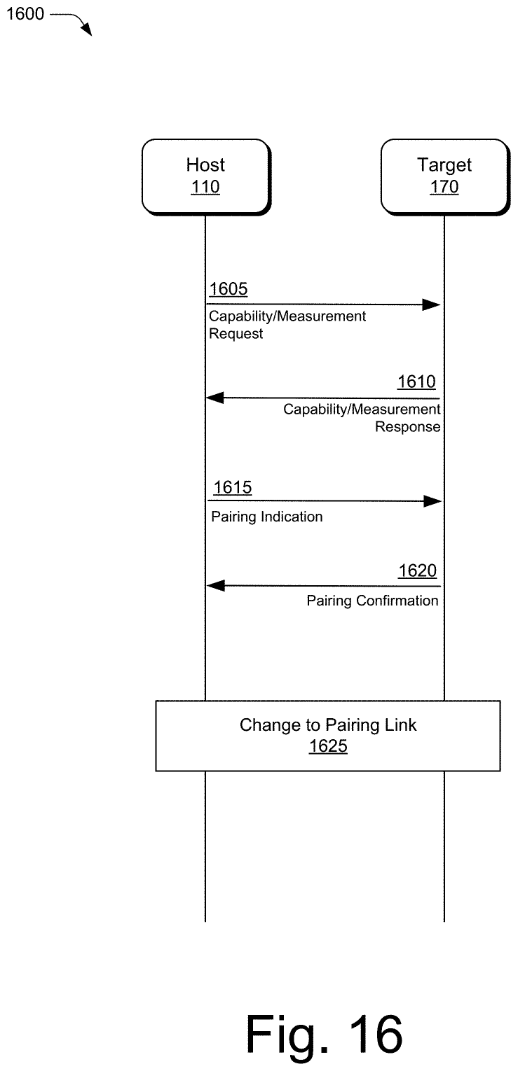

FIG. 16 illustrates data and control transactions between a host device and a target device for selecting a pairing technology in accordance with aspects of extended device pairing. Although not illustrated for the sake of illustration clarity, various acknowledgements for messages illustrated in FIG. 16 may be implemented to ensure reliable operations of extended device pairing.

At 1605, the host 110 sends a Capability/Measurement Request message to the target 170 to obtain capabilities of the target and/or to obtain measurements of candidate-pairing-technology signals measured by the target. At 1610, the target transmits its capabilities and/or measurements of candidate-pairing-technology signals to the host in a Capability/Measurement Response message.

At 1615, based on the received capabilities and/or measurements, the host 110 transmits a pairing indication to the target 170 indicating the pairing technology to use. At 1620, the target 170 transmits a pairing confirmation message to the host 110 indicating that it will use the technology indicated in the pairing indication message. At 1625, the host and the target pair based on the negotiation in the control and data transactions 1605, 1610, 1615, and 1620.

When the host and target negotiation selects licensed spectrum for the pairing, the host 110 can indicate to the base station 120 that the host and target are pairing. In one aspect, in response to informing the base station, the base station sends a command to the host and/or target to enable pairing including a sidelink resource grant. In another aspect, the base station may decide to enable pairing based on a request for pairing from the host and/or the distance between the base station and each of the host and target, as well the distance between host and the target (or the reported locations of the host and target). In a further aspect, the host and target can register their intent to pair by sending a message to the base station indicating their relationship.

In an additional aspect, carrier aggregation (CA) can be used for sidelink pairing of the host and target using a combination of licensed and unlicensed spectrum. The base station can determine the CA combinations of spectrum to use for sidelink pairing between the host and target based on a capability exchange. For example, a macro base station specifies which bands to use for the sidelink pairing. Alternatively, the host and target can use predefined configurations and select the bands they prefer from the allowed options during the pairing negotiation.

In a further aspect, for devices using a sidelink in a licensed band, the base station knows that every transmission destined for the paired device will need to be retransmitted. A Licensed Band Sidelink Network Slice can provide a downlink (DL) (host to target) sidelink spectrum access grant with each DL transmission. The network slice can also offer periodic sidelink spectrum access grants to allow for communication between host and target (e.g., for buffer status reports and other control information). The host device can request sidelink spectrum access for the target device.

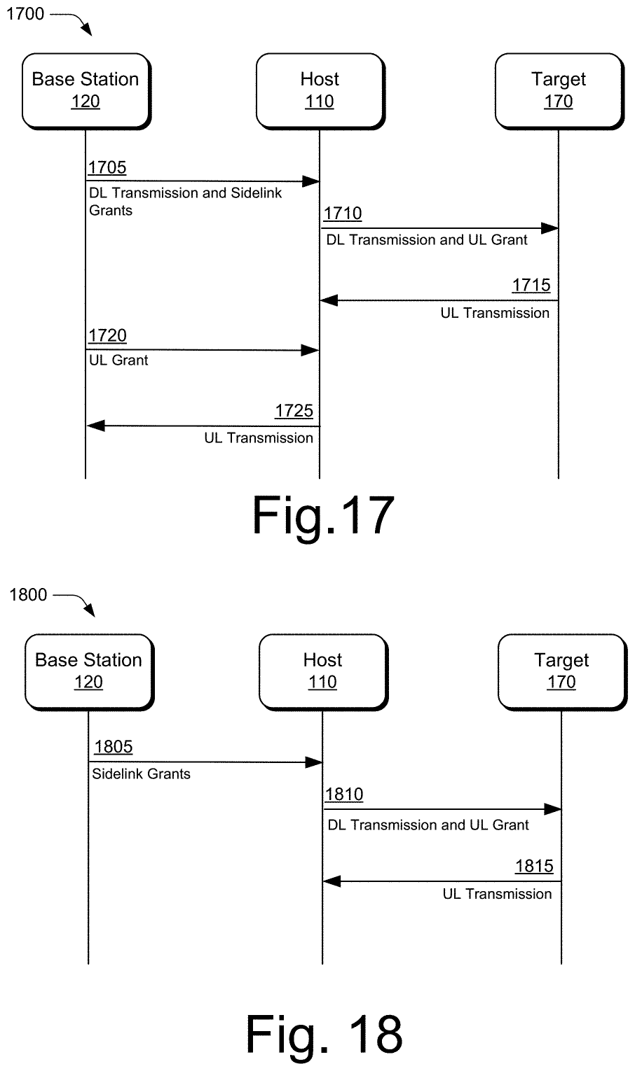

FIG. 17 illustrates data and control transactions between a host device and a target device for a sidelink network slice in accordance with aspects of extended device pairing. Although not illustrated for the sake of illustration clarity, various acknowledgements for messages illustrated in FIG. 17 may be implemented to ensure reliable operations of extended device pairing.

At 1705, the base station 120 transmits DL communications and sidelink grants to the host 110. At 1710, the host 110 transmits DL communications and an uplink (UL) grant to the target 170. At 1715, the target 170 transmits UL communications to the host 110 using the received UL grant. At 1720, the base station transmits an UL grant to the host 110. At 1725, the host 110 transmits UL communications to the base station 120 using the received UL grant. These transactions apply to cases when the base station expects the target to have UL traffic. If the host determines that there is no data from the target to relay to the base station, the host can transmit other data using the UL grant. If the base station does not expect that the target has UL data to transmit, the base station can wait for the host to request UL grants.

FIG. 18 illustrates data and control transactions between a host device and a target device for periodic sidelink grants in accordance with aspects of extended device pairing. Although not illustrated for the sake of illustration clarity, various acknowledgements for messages illustrated in FIG. 18 may be implemented to ensure reliable operations of extended device pairing.

In another aspect, the base station 120 can provide periodic sidelink grants. At 1805, the base station 120 transmits sidelink grants to the host 110. At 1810, the host 110 transmits DL communications and an uplink (UL) grant to the target 170. At 1815, the target 170 transmits UL communications to the host 110 using the received UL grant. In an alternative aspect, the target can transmit a Physical Uplink Control Channel (PUCCH) request to the host to request a resource grant when the target has UL data to transmit. Both individual (dynamic) and periodic (configured) grant can be used between the host and the target. In another aspect, periodic grants can be between the host and target only (without involvement of the base station as illustrated in FIG. 18).

These transactions apply to cases when the base station expects the target to have UL traffic. If the host determines that there is no data from the target to relay to the base station, the host can transmit other data using the UL grant. If the base station does not expect that the target has UL data to transmit, the base station can wait for the host to request UL grants.

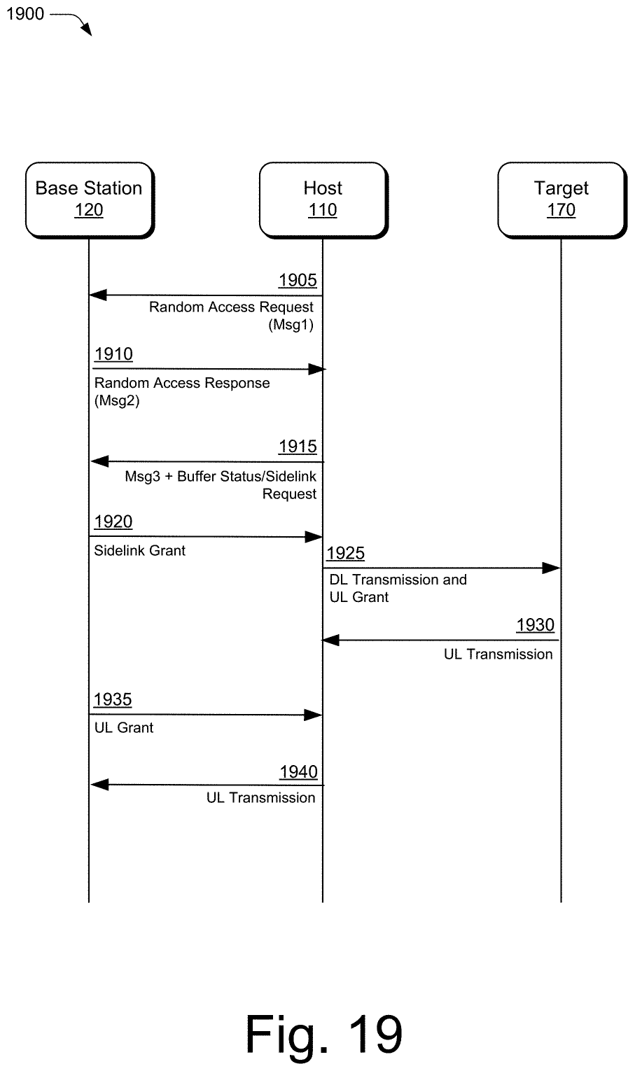

FIG. 19 illustrates data and control transactions between a host device and a target device for host requested sidelink grants in accordance with aspects of extended device pairing. Although not illustrated for the sake of illustration clarity, various acknowledgements for messages illustrated in FIG. 19 may be implemented to ensure reliable operations of extended device pairing.

At 1905, the host transmits a Random Access Request (RACH, Msg1) to the base station 120. At 1910, the base station 120 transmits a Random Access Response (Msg2) to the host 110 in response to receiving the RACH. At 1915, the host 110 transmits UL scheduling information (Msg3) and a sidelink request to the base station 120. At 1920, the base station 120 transmits sidelink grants to the host 110.

At 1925, the host 110 transmits DL communications and an uplink (UL) grant to the target 170. At 1930, the target 170 transmits UL communications to the host 110 using the received UL grant. At 1935, the base station transmits an UL grant to the host 110. At 1940, the host 110 transmits UL communications to the base station 120 using the received UL grant.

In a further aspect, an unlicensed band sidelink network slice can be used for communication between the host 110 and the target 170. In this case, the pairing link is over unlicensed 5G New Radio Unlicensed (NRU) radio spectrum, so no grants need to be given to the host and target for the pairing link. In order to minimize delays (latencies), the host and target benefit from knowing when the host to base station communications will occur. When using this type of network slice, an announcement of the schedule of future allocations (or use of periodic grants) enables the target and host to plan to communicate either just before or just after a host to base station exchange.

### Example Methods

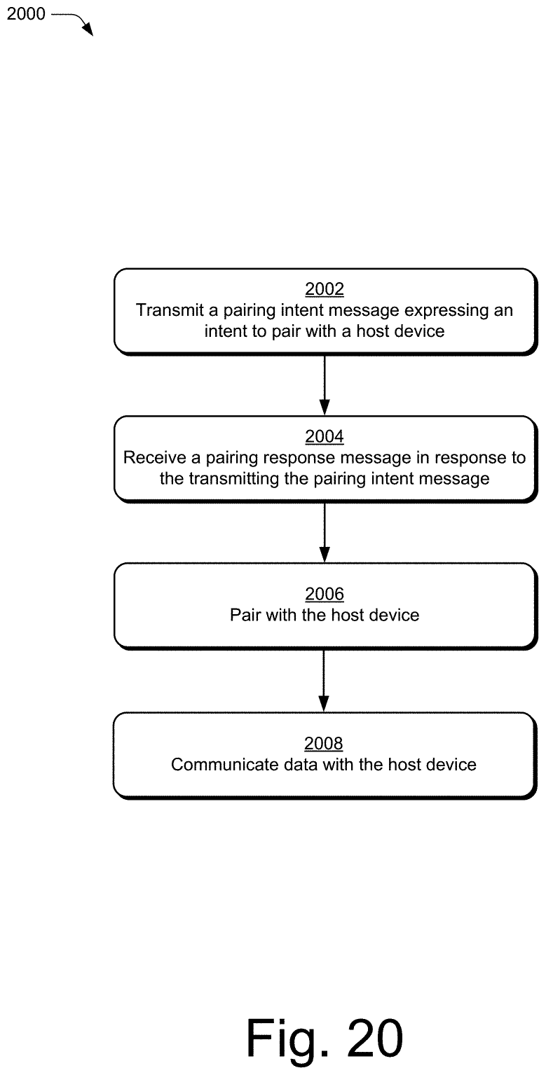

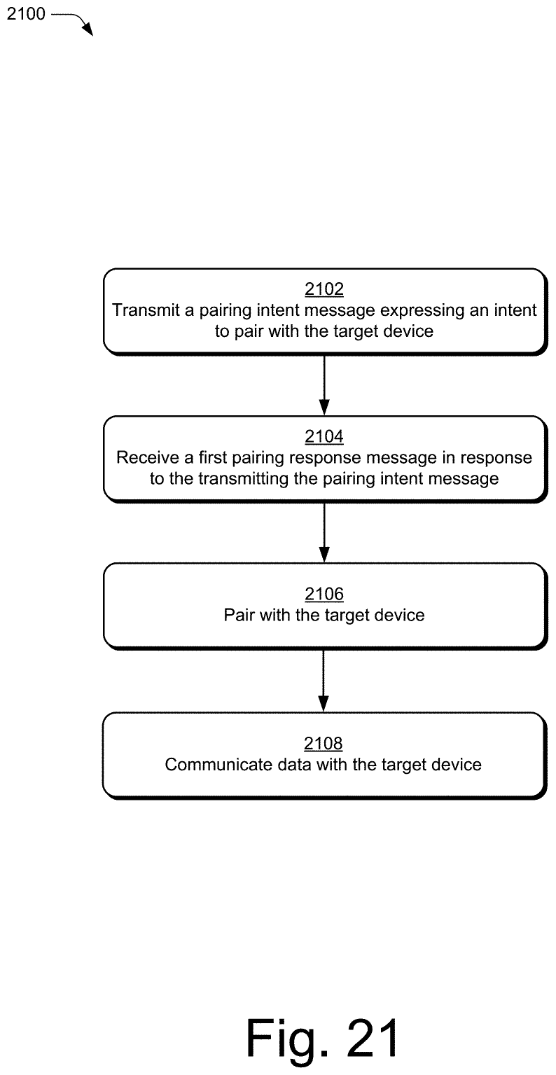

FIGS. 20 and 21 illustrates example method(s) 2000 and 2100 of extended device pairing. FIG. 20 illustrates method 2000 that generally relates to the target device establishing an extended device pairing with the host device. At 2002, a target device (e.g., the target device 170) transmits a pairing intent message expressing an intent to pair with a host device (e.g., the host device 110). For example, the target device transmits a pairing intention message directly to the host device, via a base station (e.g., the base station 120) or via a cloud service (e.g., the cloud service 190), as described in FIGS. 4-13.

At 2004, the target device receives a pairing response message in response to the transmitting the pairing intent message. For example, the target device receives a pairing response message directly from the host device, via the base station or via the cloud service, as described in FIGS. 4-13.

At 2006, the target device pairs with the host device. For example, the target device and the host device negotiate a pairing by exchanging request and confirmations messages that may optionally include exchanging capabilities and measurements to select and establish the pairing, as described in FIGS. 13-16.

At 2008, the target device and the host device communicate data over the paired link. For example, using a resource grant included in the pairing response message, the host device and the target device communicate UL and DL control and user data.

FIG. 21 illustrates method 2100 that generally relates to the host device establishing an extended device pairing with the target device. At 2102, a host device (e.g., the host device 110) transmits a pairing intent message expressing an intent to pair with a target device (e.g., the target device 170). For example, the host device transmits a pairing intention message directly to the target device, via a base station (e.g., the base station 120) or via a cloud service (e.g., the cloud service 190), as described in FIGS. 4-13.

At 2104, the host device receives a first pairing response message in response to the transmitting the pairing intent message. For example, the host device receives the first pairing response message directly from the target device, via the base station or via the cloud service, as described in FIGS. 4-13.

At 2106, the host device pairs with the target device. For example, the target device and the host device negotiate a pairing by exchanging request and confirmations messages that may optionally include exchanging capabilities and measurements to select and establish the pairing, as described in FIGS. 13-16.

At 2108, the host device and the target device communicate data over the paired link. For example, using a resource grant included in the first pairing response message, the host device and the target device communicate UL and DL control and user data.

Example methods 2000 and 2100 are described with reference to FIGS. 20 and 21 in accordance with one or more aspects of extended device pairing. The order in which the method blocks are described are not intended to be construed as a limitation, and any number of the described method blocks can be skipped, repeated, or combined in any order to implement a method or an alternate method. Generally, any of the components, modules, methods, and operations described herein can be implemented using software, firmware, hardware (e.g., fixed logic circuitry), or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

Although aspects of extended device pairing have been described in language specific to features and/or methods, the subject of the appended claims is not necessarily limited to the specific features or methods described. Rather, the specific features and methods are disclosed as example implementations of extended device pairing, and other equivalent features and methods are intended to be within the scope of the appended claims. Further, various different aspects are described, and it is to be appreciated that each described aspect can be implemented independently or in connection with one or more other described aspects.

What is claimed is:

1. A method for pairing with a host device by a target device, the method comprising the target device:
transmitting a pairing intent message expressing an intent to pair with the host device;
receiving a pairing response message in response to the transmitting the pairing intent message;
pairing with the host device; and
communicating data with the host device.

2. The method of claim 1, wherein the transmitting the pairing intent message comprises:
transmitting the pairing intent message to a base station; and
wherein the receiving the pairing response message comprises:
receiving the pairing response message from the base station.

3. The method of claim 1, wherein the transmitting the pairing intent message comprises:
transmitting the pairing intent message to a cloud service, the transmitting causing the cloud service to forward the pairing intent message to the host device.

4. The method of claim 3, wherein the transmitting the pairing intent message to the cloud service comprises:
transmitting the pairing intent message to the cloud service via a Wireless Local Area Network, WLAN, Access Point, AP.

5. The method of claim 3, wherein the receiving the pairing response message comprises:
receiving the pairing response message from the cloud service.

6. The method of 1, wherein the transmitting the pairing intent message comprises:
transmitting the pairing intent message to the host device; and
wherein the receiving the pairing response message comprises:
receiving the pairing response message from the host device.

7. The method of claim 6, wherein the transmitting the pairing intent message is in response to receiving an advertising transmission from the host device.

8. The method of claim 1, wherein the pairing response message includes a resource grant for communications between the host device and the target device.

9. A method for pairing with a target device by a host device, the method comprising the host device:
transmitting a pairing intent message expressing an intent to pair with the target device;
receiving a first pairing response message in response to the transmitting the pairing intent message;
pairing with the target device; and
communicating data with the target device.

10. The method of claim 9, wherein the transmitting the pairing intent message comprises:
transmitting the pairing intent message to a base station; and
wherein the receiving the first pairing response message comprises:
receiving the pairing response message from the base station.

11. The method of claim 10, wherein the transmitting the pairing intent message to the base station comprises:
transmitting the pairing intent message to the base station in response to receiving, from a cloud service, a pairing intent message from the target device.

12. The method of claim 10, wherein the receiving the first pairing response message comprises:
receiving the first pairing response message from the base station.

13. The method of claim 12, further comprising the host device:
transmitting a second pairing response message to the target device.

14. The method of claim 13, wherein the transmitting the second pairing response message to the target device comprises:
transmitting the second pairing response message to the target device in response to the receiving the first pairing response message.

15. The method of claim 9, wherein the pairing response message includes a resource grant for communications between the host device and the target device.

16. An apparatus comprising:
a wireless transceiver;
a processor; and
computer-readable storage media comprising instructions that, responsive to execution by the processor, direct the apparatus to:
transmit a pairing intent message expressing an intent to pair with the host device;
receive a pairing response message in response to the transmitting the pairing intent message;
pair with the host device; and
communicate data with the host device.

17. Computer-readable storage media comprising instructions that, responsive to execution by a processor, direct an apparatus to:
transmit a pairing intent message expressing an intent to pair with the host device;
receive a pairing response message in response to the transmitting the pairing intent message;
pair with the host device; and
communicate data with the host device.
